(19) United States
(12) Patent Application Publication
(10) Pub. No.: US 2008/0086386 A1
(43) Pub. Date: Apr. 10, 2008

(54) Conducting Remote Shopping Events

(76) Inventor: Stephen F. Bell, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/867,049

(22) Filed: Oct. 4, 2007

Related U.S. Application Data
(60) Provisional application No. 60/850,985, filed on Oct. 10, 2006.

(51) Int. Cl. G06Q 30/00

(52) U.S. Cl. 705/26

(57) ABSTRACT

System and method for conducting a remote shopping event. The method may include scheduling the remote shopping event for a first shopper. The remote shopping event may occur at a first location while the first shopper may be located at a second location which is remote from the first location. A video camera may be provided for generating video corresponding to the remote shopping event at the first location. The first shopper may provide input to direct the video camera to provide video of a plurality of items to the first shopper. The video of the plurality of items may be provided over a wide area network for display, wherein the video is viewable by the first shopper. The shopper and/or one or more other shoppers may purchase one or more of the items.

### FIELD OF THE INVENTION

The present invention relates to the field of online shopping, and more particularly to a system and method for conducting a remote shopping event.

### DESCRIPTION OF THE RELATED ART

In recent years, online shopping has become increasingly popular. In particular, many users have begun doing most of their shopping using online websites (e.g., Amazon, Ebay, etc.) rather than physically shopping for goods and/or services.

In general, goods produced in foreign countries are oftentimes available for cheaper prices than in the user's own country (e.g., the United States). For example, the same goods may be available in shops in the foreign country of origin at wholesale (or relatively cheap) prices. However, users typically do not have the opportunity to do shopping directly in those foreign countries. Correspondingly, improvements in online shopping are desired.

### SUMMARY OF THE INVENTION

Various embodiments are presented of a system and method for conducting a remote shopping event.

A first shopper may register for a remote shopping event or register as a user on a server. In one embodiment, the first shopper may provide information to a web site to register as a user. The user may provide personal information (e.g., including first name, last name, zip code, phone number, e-mail address, billing information (including, possibly, credit card information, bank account information, online payment information, etc.), shipping information, home and work addresses, and/or other information). The first shopper may also provide the type of items the first shopper would like to shop for as well as any other questions they might have.

The remote shopping event may be scheduled for the first shopper. In some embodiments, the remote location or store for which the event occurs may choose the first shopper, e.g., based on the first shopper's items of interest, previous shopping history (e.g., how popular the first shopper's purchases have been), personal information, income, the schedule of the first shopper, the capabilities of the shopper to perform the remote shopping event (e.g., ownership/plans of a cell phone and/or an wide area network connection, such as the Internet), and/or other information regarding the first shopper. Alternatively, the first shopper may pay a fee or subscription to be the “power buyer” (in these descriptions, the first shopper) for the remote shopping event.

A video camera (or a plurality of video cameras) may be provided for generating video corresponding to the remote shopping event. The video camera may be positioned at a retail location (e.g., a shop) at a first location. The video camera is preferably mobile, and as discussed further below may be moved and/or swiveled, etc., as directed by the first shopper. As indicated above, the first location may be remote from the location of the first shopper. In other words, the video camera may be positioned at a first location, e.g., in a foreign country, while the first shopper may be in a second location that is remote from the first location. For example, as indicated above, the first shopper may be using a home computer in the United States, and the video camera(s) may be at a particular store or retail location in Shanghai.

The first location (the remote location) may be prepared to conduct the remote shopping event. Accordingly, cell phone(s), audio recording device(s), video camera(s), a remote computer system, a mixer, and/or other equipment may be positioned for performing the remote shopping event at the remote location. In one embodiment, two different video feeds or streams may be set up for the remote shopping event. A first feed may be set up for the first shopper which has a first priority. The first video feed may be set up such that the first shopper can receive video from the remote location in real time, i.e., substantially viewing actions on the video as they are occurring at the remote location. The first video feed may or may not be set up to transmit audio data from the various audio recording devices (e.g., to ensure lower latency of the video feed to the first shopper). In embodiments where audio is not transmitted via the first video feed, the first shopper may use a cell phone or other audio only device to transmit and/or receive audio to/from the remote location. However, the first shopper may simply use a network connection (e.g., over the Internet) to perform all audio and video communications, as desired.

A second video feed may also be set up, which may have a lower priority and may be used for transmission to one or more other shoppers (e.g., “pile on” shoppers). These shoppers may receive the second video feed via a web site hosting the event, and the second video feed may include audio from a portion or all of the audio recording devices. The second video feed may have higher latencies (e.g., 20 seconds to a minute outside of real time) than the first video feed. The second video feed may be optimized such that minimal or no video or audio loss occurs. However, in some embodiments, all of the shoppers may view the same video feed, as desired.

In one embodiment, one or more items at the remote location may be prepared for video or picture capture to be featured on the web site, e.g., prior to or at the beginning of the remote shopping event. Additionally, a new directory or web page may become available on the web site or server system to allow the first shopper and/or a plurality of other shoppers to view and/or participate in the remote shopping event. However, following embodiments from above, two or more web sites/pages may be used according to the number of video feeds provided by the web site. For example, a private web page may be used for the first shopper to receive the first video stream, and a public web page may be used for the other shoppers to receive the second video stream. Additionally, the one or more items prepared above may be displayed on the new web page(s) prior to or at the beginning of the remote shopping event.

Thus, the remote location and the web site may be prepared, including the provision of video cameras for providing video to the first shopper/other shoppers) before the beginning of the remote shopping event.

Input may be received from the first shopper to direct the video camera to provide video of a plurality of items, and the video may be provided over a wide area network for display. As indicated above, the first shopper may receive a first video feed and a plurality of other shoppers may receive a second video feed, as desired. However, as noted above, the first shopper and the plurality of other shoppers may instead simply receive the same video feed.

The first shopper may provide the input (to direct the video camera) via a variety of means. For example, the first shopper may provide the input using a cell phone which is in contact with the agent at the remote location. However, the first shopper may communicate with the agent using other communication methods, e.g., by providing text messages to the agent (e.g., via various clients, or using a chat window of the first web site) and/or other methods. In some embodiments, the first shopper may provide input to the first video camera(s) and/or the agent using trackball, speech, joysticks, analysis of facial expressions, etc.

For example, in one embodiment, the first shopper may remotely control the video camera using a joystick. In such an embodiment, the video camera may be moveable on a robotic arm or may be a mobile video camera (e.g., with wheels or tread) which may operate remotely via the joystick. Alternatively, the joystick may send commands to a video camera operator who may respond to the joystick movements (e.g., moving the joystick up may send a command to the camera operator telling him/her to move forward and/or aim the video camera to a higher location, among other variations).

In one embodiment, whenever a first shopper is interested in a particular item, information may be sent to the first shopper, e.g., using the first web page or via other means (such as email, or cell phone messaging). The information may include a still picture of the item, a brochure of the item, pricing information, and/or other information related to the item or items. In one embodiment, the first shopper may interact with the agent and/or control the video camera using videoconferencing.

The agent may act as a proxy or remote shopper for the first shopper to provide various services for the first shopper. For example, the first shopper may tell the agent to show and/or examine various items in the remote location. Correspondingly, the video camera(s) may provide video of those items (e.g., by the agent or other associates of the remote shopping event moving the video cameras to those items) over the wide area network. As indicated above, the first shopper may view the live video using a web page hosted by a web site on the Internet. However, the first shopper may receive the videos over any network and may use any of a variety of applications. In other words, the method is not limited to using the Internet and/or web pages or web sites.

Furthermore, the first shopper may also instruct the agent to try on various items (e.g., clothes, jewelry, and/or other apparel), use various devices (e.g., demo functionality of an electronic device, ensure operability of devices, etc.), negotiate a price of an item, purchase an item, and/or perform other remote buying activities. Correspondingly, the video camera(s) may provide video of the agent performing the actions requested by the first shopper.

Additionally, the first shopper may add items to a “wish list” (or other list) as the first shopper discovers items that he/she likes or may wish to purchase. The first shopper may also simply add certain items to a featured list or suggested list which may allow the other shoppers (e.g., the “pile on” shoppers) to purchase items from the list. The first shopper may also be able to chat with the other shoppers using a chat window (e.g., provided by the web site associated with the remote shopping event). The other shoppers may provide input to the first shopper as to what items they may be interested in buying and/or viewing. In some embodiments, the price of an item for the first shopper and/or the other buyers may decrease if more buyers purchase the item (i.e., prices may go down due to a bulk buy by a plurality of the first shopper and the other “pile on” shoppers). Correspondingly, the first shopper may act cooperatively with the other shoppers in order to receive a better price on items. In some embodiments, the first shopper may interact with the other shoppers and/or the agent using videoconferencing.

While the first shopper is directing the remote shopping event (or even after the remote shopping event), the method may include (e.g., the web site may automatically perform) providing statistics to the first shopper indicating the degree of interest for various items being shown or exhibited, the number of replays of a particular portion (or all) of the video of the remote shopping event or of a particular item, the number of watching viewers, the number of purchases for a particular item, etc.

The remote shopping event may end. After the remote shopping event is ended, the video may be posted as an event on a server, e.g., the web site, for replay by other users, e.g., of the web site. In one embodiment, the remote shopping event video may be edited to a shorter version (e.g., just including the different items purchased, or just highlights of the video). Additionally, the web discussions during the event may be provided on the web site so that other users may read the live discussion at a later time. Some or all of the purchased or viewed items may be available for purchase after the event. Correspondingly, users of the web site (or other service where the content is not provided on a web site) may purchase goods shown or purchased during the remote shopping event after the event occurs.

In one embodiment, the price of the products may still decrease as later shoppers purchase goods (e.g., using the replay video, or featured items of the replay video). For example, the first shopper may have purchased a necklace for 45 dollars, but the price may decrease to 35 dollars due to the increase in purchasers after the first event. In some embodiments, the first shopper may be charged 45 or 35 dollars depending on when the additional purchases were placed. For example, the first shopper may not be charged as much if the other purchases occur before shipment of the item (in this case, the necklace). Thus, in some embodiments, the items for purchase may decrease in price after the remote shopping event.

Finally, purchased items may be shipped to the various shoppers at the respective agreed prices.

### BRIEF DESCRIPTION OF THE DRAWINGS

A better understanding of the present invention can be obtained when the following detailed description of the preferred embodiment is considered in conjunction with the following drawings, in which:

FIG. 1A illustrates an exemplary computer system for conducting a remote shopping event according to an embodiment;

FIG. 1B illustrates an exemplary computer system for conducting a remote shopping event according to an embodiment;

FIG. 2 is a flowchart diagram illustrating one embodiment of a method for conducting a remote shopping event, according to an embodiment; and

FIGS. 3 and 4 are exemplary screen shots of a website for conducting a remote shopping event, according to an embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

### Terms

The following is a glossary of terms used in the present application:

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, and/or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

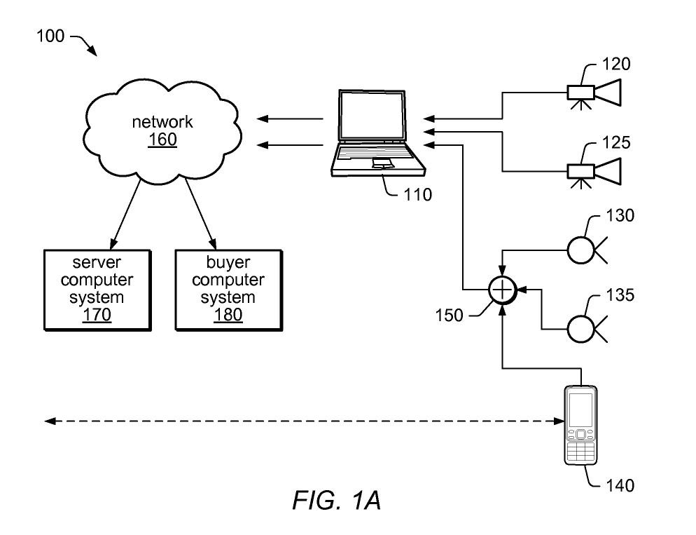

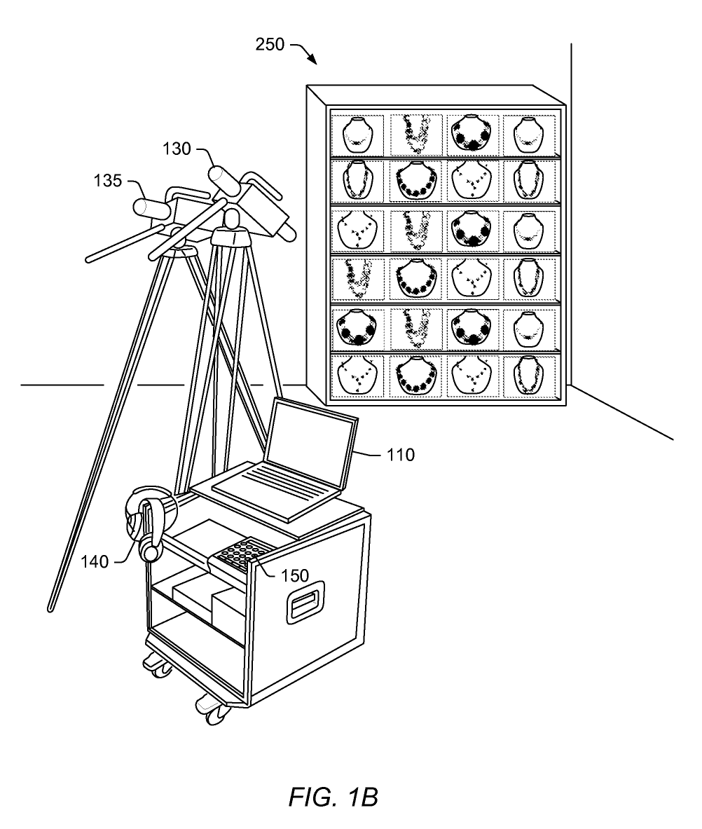

### FIG. 1A—Remote Buying System

FIG. 1A illustrates a remote buying system 100 operable to conduct a remote buying event as described herein. Note that FIG. 1A presents an exemplary system only and that modifications and variations of the system shown are envisioned. For example, one or more other devices or systems may be added to the remote buying system 100 and/or one or more of the shown devices and systems may be omitted, as desired.

As shown in FIG. 1A, the remote buying system 100 may include a computer system 110 (shown as a laptop computing system in FIG. 1A). The computer system 110 may include a display device and user input devices (e.g., keyboard and mouse). The computer system 100 may include at least one memory medium on which one or more computer programs or software components according to one embodiment of the present invention may be stored. These computer programs/software may execute to perform various ones of the methods described herein. For example, the computer system 110 may execute software to provide video and/or audio of a remote shopping event to potential buyers (e.g., including the shopper conducting the remote shopping event and/or other users observing the remote shopping event). In some embodiments, the computer system 110 may store software operable to encode video and/or using various codecs, e.g., H.264, mp3, and/or other codecs. The memory medium may also store operating system software, as well as other software for operation of the computer system. Various embodiments further include receiving or storing instructions and/or data implemented in accordance with the foregoing description upon a carrier medium.

As also shown, the computer system 110 may be coupled to camera A 120 and camera B 125. Although FIG. 1A only includes two video cameras, other numbers of video cameras are envisioned. For example, only one video camera or a plurality of video cameras (i.e., two or more video cameras) may be used. The video cameras may operate to provide video to the computer system 110 for transmission to a server computer and/or a user computer (e.g., a shopper). Additionally, in one embodiment, the computer system 110 may be incorporated into one or more of the cameras 120 and 125 (and/or other devices of the remote shopping system 100). For example, one or more of the video cameras may be “smart” cameras which include a processor and memory and may be operable to perform the methods described herein (e.g., the methods associated with the computer system 110). In some embodiments, the video cameras may record in a codec, or include the ability to encode incoming and/or outgoing video according to various codecs, such as H.264, among others.

The remote buying system 100 may also include one or more audio recording devices (e.g., merchant label microphone 130, agent lapel microphone 135, and/or agent cell phone 140). The audio recording devices may be microphones or other audio recording devices. The audio recording devices may encode the audio in various codecs (e.g., mp3, among others) or may be operable to convert audio into various codecs. In some embodiments, the audio recording devices may be wired or wireless, as desired. Additionally, the recording devices may also be incorporated into one or more of the video cameras or computer systems described herein. Similar to above, note that these recording devices are exemplary only and more or less audio devices may be used for various purposes. For example, other audio devices may be used at the remote location (e.g., the remote shop or retail location) to capture ambient sounds of the remote location.

One or more of these audio signals may be aggregated by the audio mixer 150 which may provide the aggregated audio signals to the computer system 110. Note that the cell phone 140 may also be used to provide audio (e.g., via typical cell phone means for transmission and/or using voice over IP (VOIP)) to the user (also referred to as a shopper or buyer). The cell phone 140 may or may not provide its audio for aggregation by the audio mixer 150. It should be noted that the cell phone may not be required to perform remote buying as described herein. For example, audio may be provided to a buyer computer system 180 using network 160 (possibly via server computer system 170). Various protocols may be used including VOIP to provide audio to the shopper and/or other shoppers, e.g., over the Internet.

As shown, the computer system 110 may be coupled to the server computer system 170 via the network 160. The network 160 can also be any of various types, including a LAN (local area network), WAN (wide area network), the Internet, or an Intranet, among others. Additionally, the computer system 110 may provide the video and/or data recorded by the video cameras and/or the audio recording devices shown in FIG. 1A (among others) to the server computer system 170.

The server computer system 170 may be any type of computing system. In one embodiment, the server computer system 170 may include a processor and memory, and the memory may store program instructions executable to host a web site. The server computer system 170 may further execute software to receive the video and audio data from the computer system 110 and provide that data using the web site. Further, a buyer computer system 180 may execute (using a processor) software to browse the web site of the server computer system 170 via the network 160. However, in some embodiments, the buyer computer system 180 may simply execute an application (e.g., other than a web browser) to receive the audio and/or video data transmitted by the computer system 110. In other words, the server computer system 170 may or may not be required, and additionally, may or may not need to provide the video and/or audio data using the web site. Additionally, it should be noted that while FIG. 1A shows a single network coupling the various computer systems, more than one network may be used. For example, a first network may be used between the remote computer system 110 and the server computer system 170 and a second network (e.g., the Internet) may be used between the server computer system 170 and the buyer computer system 180.

Thus, FIG. 1A illustrates an exemplary remote buying system.

### FIG. 1B—Exemplary Remote Location

FIG. 1B illustrates an exemplary remote location and set up using the remote buying system 100. As shown, the remote location includes portions of the remote buying system 100. In this case, the remote location of FIG. 1B includes video cameras 120 and 125, audio mixer 150, computer system 110, and cell phone 140 (with audio headset). The remote location further includes (not shown) the recording devices 130 and 135 and an additional computer which may be used for real time description and picture upload (e.g., to the computer server 170). Additionally, the remote location includes various items available for purchase 150.

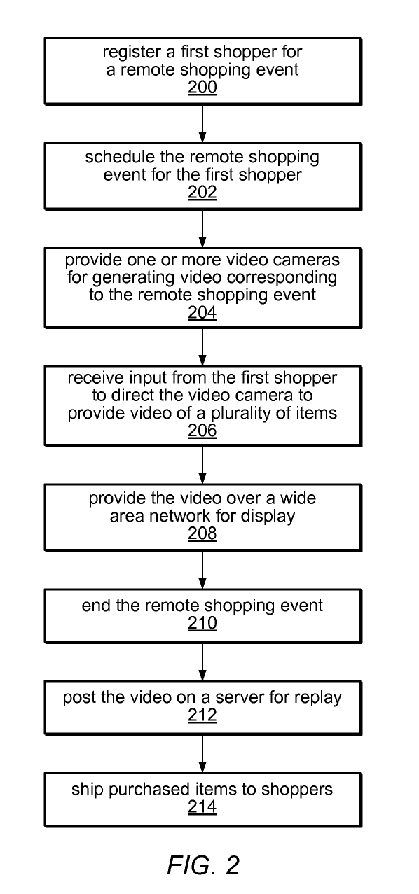

### FIG. 2—Method for Conducting a Remote Shopping Event

FIG. 2 illustrates a method for conducting a remote shopping event. The method shown in FIG. 2 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 200, a first shopper may register for a remote shopping event or register as a user on a server. As used herein, the term “remote shopping event” refers to an event whereby the first shopper remotely instructs or controls an agent to purchase or examine goods for the shopper at a remote location. Further descriptions of the remote shopping event are described below.

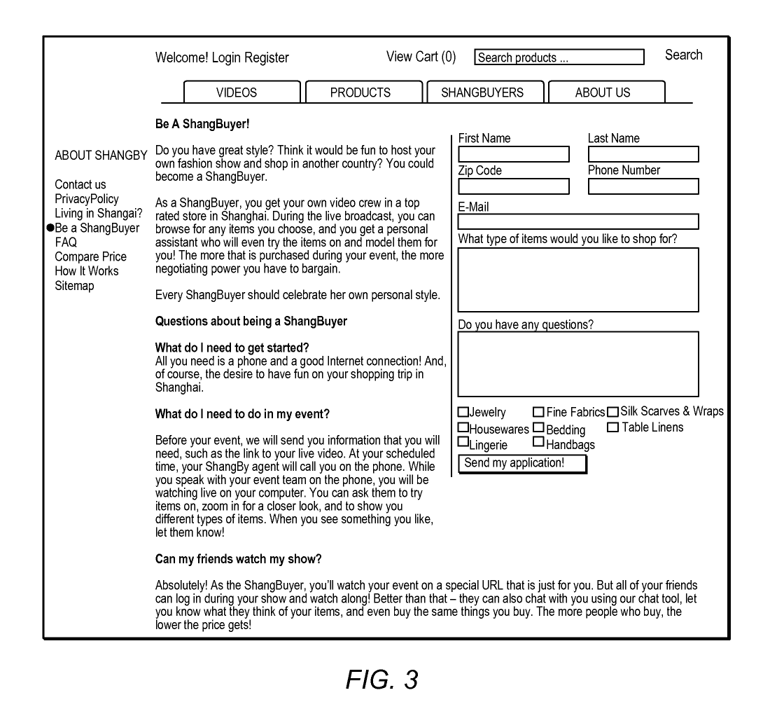

In one embodiment, the first shopper may provide information to a web site to register as a user. As one example, the website may be “www.shangby.com” (e.g., to purchase goods from Shanghai) among other web sites. However, note that other locations and websites are envisioned. In one embodiment, the first shopper may register using a registration web page on the web site as shown in the exemplary web page of FIG. 3. As shown in FIG. 3, the user may provide personal information (e.g., including first name, last name, zip code, phone number, e-mail address, billing information (including, possibly, credit card information, bank account information, online payment information, etc.), shipping information, home and work addresses, and/or other information). The first shopper may also provide the type of items the first shopper would like to shop for as well as any other questions they might have. Additionally, as shown, the first shopper may read information about becoming a “buyer” or “power buyer” of the remote shopping event. As shown, the registration web page may include the following descriptive text:
Be A ShangBuyer!
Do you have great style? Think it would be fun to host your own fashion show and shop in another country? You could become a ShangBuyer. As a ShangBuyer, you get your own video crew in a top rated store in Shanghai. During the live broadcast, you can browse for any items you choose, and you get a personal assistant who will even try the items on and model them for you! The more that is purchased during your event, the more negotiating power you have to bargain. Every ShangBuyer should celebrate her own personal style.
Questions about being a ShangBuyer
What do I need to get started? All you need is a phone and a good Internet connection! And, of course, the desire to have fun on your shopping trip in Shanghai. What do I need to do in my event? Before your event, we will send you information that you will need, such as the link to your live video. At your scheduled time, your ShangBy agent will call you on the phone. While you speak with your event team on the phone, you will be watching live on your computer. You can ask them to try items on, zoom in for a closer look, and to show you different types of items. When you see something you like, let them know! Can my friends watch my show? Absolutely! As the ShangBuyer, you'll watch your event on a special URL that is just for you. But all of your friends can log in during your show and watch along! Better than that—they can also chat with you using our chat tool, let you know what they think of your items, and even buy the same things you buy. The more people who buy, the lower the price gets!

Note that the above section describes only one embodiment of a potential remote shopping event and registration, and is not intended to limit the scope of the methods described herein. For example, other websites, remote locations, personal information, etc. are envisioned.

The registration web page shown in FIG. 3 may also include a search bar (for searching the website), tabs for viewing videos of previous remote shopping events, available products, other buyers (e.g., for social networking on the web site), and/or other links. Thus, FIG. 3 illustrates an exemplary registration web page for a remote shopping event.

In 202, the remote shopping event may be scheduled for the first shopper. In some embodiments, the remote location or store for which the event occurs may choose the first shopper, e.g., based on the first shopper's items of interest, previous shopping history (e.g., how popular the first shopper's purchases have been), personal information, income, the schedule of the first shopper, the capabilities of the shopper to perform the remote shopping event (e.g., ownership/plans of a cell phone and/or an wide area network connection, such as the Internet), and/or other information regarding the first shopper. Alternatively, the first shopper may pay a fee or subscription to be the “power buyer” (in these descriptions, the first shopper) for the remote shopping event.

Scheduling the remote shopping event may include one or more telephone conversations with the first shopper, one or more emails, one or more text conversations, and/or other methods of communications. Ultimately, scheduling the remote shopping event results in the scheduling of a specific time to perform the remote shopping event. Once scheduled, the remote shopping event or an indication of the upcoming remote shopping event may be posted on a web page (e.g., Shangby.com following the example from above) where other users may choose to participate in the remote shopping event. Additionally, the method may include (e.g., the web site may automatically perform) sending a notification to users of the web site of the upcoming remote shopping event, e.g., including the specified time and particulars of the remote shopping event (such as the types of items being shopped, the location, the name of the store, etc.). The notification(s) to the users/shoppers may include emails, letters, instant messages, text messages, telephone calls, etc.

In 204, a video camera (or a plurality of video cameras) may be provided for generating video corresponding to the remote shopping event. The video camera may be positioned at a retail location (e.g., a shop) at a first location. The video camera is preferably mobile, and as discussed further below may be moved and/or swiveled, etc., as directed by the first shopper. As indicated above, the first location may be remote from the location of the first shopper. In other words, the video camera may be positioned at a first location, e.g., in a foreign country, while the first shopper may be in a second location that is remote from the first location. For example, as indicated above, the first shopper may be using a home computer in the United States, and the video camera(s) may be at a particular store or retail location in Shanghai.

In various embodiments, the remote location may be set up using the remote shopping system 100 of FIG. 1A, e.g., in the manner described and shown in FIG. 1B. Thus, the first location (the remote location) may be prepared to conduct the remote shopping event. Accordingly, cell phone(s), audio recording device(s), video camera(s), the remote computer system, the mixer, and/or other equipment may be positioned for performing the remote shopping event at the remote location. In one embodiment, two different video feeds or streams may be set up for the remote shopping event. A first feed may be set up for the first shopper which has a first priority. The first video feed may be set up such that the first shopper can receive video from the remote location in real time, i.e., substantially viewing actions on the video as they are occurring at the remote location. However, it should be noted that some lag (e.g., a few seconds) may be involved due to the distance of communication between the first location and the second location, and the speed at which video is converted to digital formats, etc. The first video feed may be optimized to minimize delay or prioritize the real time aspects of the video feed over audio, video, or other packet loss. In other words, the first video feed may skip frames or audio in order to stay “real time”. The first video feed may or may not be set up to transmit audio data from the various audio recording devices (e.g., to ensure lower latency of the video feed to the first shopper). In embodiments where audio is not transmitted via the first video feed, the first shopper may use a cell phone or other audio only device to transmit and/or receive audio to/from the remote location. However, as noted above, the first shopper may simply use a network connection (e.g., over the Internet) to perform all audio and video communications, as desired.

A second video feed may also be set up, which may have a lower priority and may be used for transmission to one or more other shoppers (e.g., “pile on” shoppers). These shoppers may receive the second video feed via a web site hosting the event, and the second video feed may include audio from a portion or all of the audio recording devices. The second video feed may have higher latencies (e.g., 20 seconds to a minute outside of real time) than the first video feed. Note that the other shoppers and the first shopper may be able to change or set preferences for which audio devices are transmitted to the user, or may be able to switch to different video feeds (e.g., depending on the numbers of cameras used) and/or select different subsets of the audio devices to hear before or during the remote shopping event. Note also that different streaming servers may be used for the different video feeds (e.g., a first streaming server with minimal routing and/or relays for the first video feed, and a second streaming server with lower priority for the second video feed). The second video feed may be optimized such that minimal or no video or audio loss occurs. However, in some embodiments, all of the shoppers may view the same video feed, as desired.

In one embodiment, one or more items at the remote location may be prepared for video or picture capture to be featured on the web site, e.g., prior to or at the beginning of the remote shopping event. Additionally, a new directory or web page may become available on the web site or server system to allow the first shopper and/or a plurality of other shoppers to view and/or participate in the remote shopping event. However, following embodiments from above, two or more web sites/pages may be used according to the number of video feeds provided by the web site. For example, a private web page may be used for the first shopper to receive the first video stream, and a public web page may be used for the other shoppers to receive the second video stream. Additionally, the one or more items prepared above may be displayed on the new web page(s) prior to or at the beginning of the remote shopping event.

Furthermore, one or more notifications (such as those described above, among others) may be sent to the first shopper and/or other shoppers when this new web page appears (e.g., to indicate the beginning of the remote shopping event) or just before the remote shopping event occurs. In one embodiment, an agent of the remote shopping event may contact (e.g., using a cell phone or other communication device) the first shopper to establish communication for the remote shopping event. Additionally, before the remote shopping event, the first shopper may invite one or more friends or other shoppers on the web site to view the new web page for the remote shopping event (e.g., using the notifications above). Thus, the remote location and the web site may be prepared, including the provision of video cameras for providing video to the first shopper/other shoppers) before the beginning of the remote shopping event.

In 206, input may be received from the first shopper to direct the video camera to provide video of a plurality of items, and in 208, the video may be provided over a wide area network for display. As indicated above, the first shopper may receive a first video feed and a plurality of other shoppers may receive a second video feed, as desired. However, as noted above, the first shopper and the plurality of other shoppers may instead simply receive the same video feed.

The first shopper may provide the input (to direct the video camera) via a variety of means. For example, the first shopper may provide the input using a cell phone which is in contact with the agent at the remote location. However, the first shopper may communicate with the agent using other communication methods, e.g., by providing text messages to the agent (e.g., via various clients, or using a chat window of the first web site) and/or other methods. In some embodiments, the first shopper may provide input to the first video camera(s) and/or the agent using trackball, speech, joysticks, analysis of facial expressions, etc.

For example, in one embodiment, the first shopper may remotely control the video camera using a joystick. In such an embodiment, the video camera may be moveable on a robotic arm or may be a mobile video camera (e.g., with wheels or tread) which may operate remotely via the joystick. Alternatively, the joystick may send commands to a video camera operator who may respond to the joystick movements (e.g., moving the joystick up may send a command to the camera operator telling him/her to move forward and/or aim the video camera to a higher location, among other variations).

As also indicated above, the expression or location of the first shopper's interest (e.g., where the first shopper's eyes are focused and/or the direction of the first shopper's face) may be interpreted, e.g., by software, to instruct movement of the video camera. For example, if the video screen on the shopper's computer shows a plurality of items, software may execute to analyze where the shopper's attention is focused, e.g., on one of the items. Correspondingly, that item may be presented in a closer view, shown by the agent, a price indication may appear, etc. Similarly, in one embodiment, whenever a first shopper is interested in a particular item, information may be sent to the first shopper, e.g., using the first web page or via other means (such as email, or cell phone messaging). The information may include a still picture of the item, a brochure of the item, pricing information, and/or other information related to the item or items. In one embodiment, the first shopper may interact with the agent and/or control the video camera using videoconferencing.

The agent may act as a proxy or remote shopper for the first shopper to provide various services for the first shopper. For example, the first shopper may tell the agent to show and/or examine various items in the remote location. Correspondingly, the video camera(s) may provide video of those items (e.g., by the agent or other associates of the remote shopping event moving the video cameras to those items) over the wide area network. As indicated above, the first shopper may view the live video using a web page hosted by a web site on the Internet. However, the first shopper may receive the videos over any network and may use any of a variety of applications. In other words, the method is not limited to using the Internet and/or web pages or web sites.

Furthermore, the first shopper may also instruct the agent to try on various items (e.g., clothes, jewelry, and/or other apparel), use various devices (e.g., demo functionality of an electronic device, ensure operability of devices, etc.), negotiate a price of an item, purchase an item, and/or perform other remote buying activities. Correspondingly, the video camera(s) may provide video of the agent performing the actions requested by the first shopper.

Additionally, the first shopper may add items to a “wish list” (or other list) as the first shopper discovers items that he/she likes or may wish to purchase. The first shopper may also simply add certain items to a featured list or suggested list which may allow the other shoppers (e.g., the “pile on” shoppers) to purchase items from the list. The first shopper may also be able to chat with the other shoppers using a chat window (e.g., provided by the web site associated with the remote shopping event). The other shoppers may provide input to the first shopper as to what items they may be interested in buying and/or viewing. In some embodiments, the price of an item for the first shopper and/or the other buyers may decrease if more buyers purchase the item (i.e., prices may go down due to a bulk buy by a plurality of the first shopper and the other “pile on” shoppers). Correspondingly, the first shopper may act cooperatively with the other shoppers in order to receive a better price on items. In some embodiments, the first shopper may interact with the other shoppers and/or the agent using videoconferencing. For example, the other shoppers may talk to the first shopper (e.g., based on user input or settings of preferences of the first shopper) using videoconferencing.

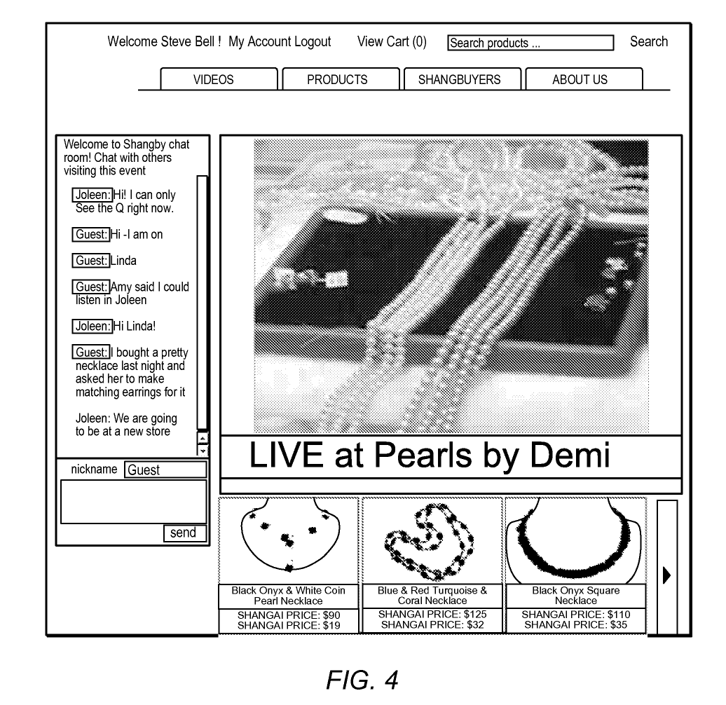

FIG. 4 illustrates one embodiment of a web page which may be displayed for the first shopper and/or the other shoppers. As shown, FIG. 4 includes a video feed portion where the video from the video camera(s) are displayed. FIG. 4 also includes a text chat portion on the left hand side where the shoppers may interact during the remote shopping event as well as a bottom portion for various items (e.g., featured, wish list, purchased, and/or other items). As shown, the various items may include a picture of the item, a description, a price at the remote location, and total price (displayed as “Shangby Price”), which may include various ones of the fees/commissions described above.

The video provided by the video cameras may also be processed before it is provided over the wide area network. For example, price tags or price indications may be added to visible items in the video before they are viewed by the first shopper and/or the other shoppers. In one embodiment, the prices for purchase (e.g., included in the price indications or simply during purchase/negotiation) may or may not include a shipping charge, commission charges, foreign country charges, taxes, importing fees, and/or other charges. As noted above, the charge of an item may decrease based on increasing numbers of purchasers of an item (or from the store in general).

While the first shopper is directing the remote shopping event (or even after the remote shopping event), the method may include (e.g., the web site may automatically perform) providing statistics to the first shopper indicating the degree of interest for various items being shown or exhibited, the number of replays of a particular portion (or all) of the video of the remote shopping event or of a particular item, the number of watching viewers, the number of purchases for a particular item, etc.

In 210, the remote shopping event may end. In some embodiments, the ending of the remote shopping event may be prescheduled or may be determined during the remote shopping event. In one embodiment, a countdown timer indicating when the remote shopping event is ending may be displayed for the first shopper and/or the other shoppers watching the remote shopping event.

In 212, after the remote shopping event is ended, the video may be posted as an event on a server, e.g., the web site, for replay by other users, e.g., of the web site. In one embodiment, the remote shopping event video may be edited to a shorter version (e.g., just including the different items purchased, or just highlights of the video). Additionally, the web discussions during the event may be provided on the web site so that other users may read the live discussion at a later time. Some or all of the purchased or viewed items may be available for purchase after the event. Correspondingly, users of the web site (or other service where the content is not provided on a web site) may purchase goods shown or purchased during the remote shopping event after the event occurs.

In one embodiment, the price of the products may still decrease as later shoppers purchase goods (e.g., using the replay video, or featured items of the replay video). For example, the first shopper may have purchased a necklace for 45 dollars, but the price may decrease to 35 dollars due to the increase in purchasers after the first event. In some embodiments, the first shopper may be charged 45 or 35 dollars depending on when the additional purchases were placed. For example, the first shopper may not be charged as much if the other purchases occur before shipment of the item (in this case, the necklace). Thus, in some embodiments, the items for purchase may decrease in price after the remote shopping event.

In 214, purchased items may be shipped to the various shoppers at the respective agreed prices.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for conducting a remote shopping event, comprising:
scheduling the remote shopping event for a first shopper;
providing a video camera for generating video corresponding to the remote shopping event, wherein the remote shopping event occurs at a first location;
receiving input from the first shopper to direct the video camera to provide video of a plurality of items to the first shopper;
providing the video of the plurality of items over a wide area network for display, wherein the video is viewable by the first shopper, and wherein the first shopper is located at a second location that is remote from the first location.

2. The method of claim 1,
receiving input from the first shopper to purchase at least one item of the plurality of items displayed on the video.

3. The method of claim 1, further comprising:
providing a sales price of an item of the plurality of items to the first shopper, wherein the sales price includes shipping and a transaction charge.

4. The method of claim 1,
wherein said providing the video comprises providing the video to a web site for presentation over the wide area network, wherein the video displayed on the web site is viewable by a plurality of other shoppers; and
wherein the method further comprises receiving input from at least one of the plurality of other shoppers to purchase at least one item displayed on the video on the first web site.

5. The method of claim 4, further comprising:
providing audio equipment for generating audio of the remote shopping event;
providing the audio of the remote shopping event over the wide area network to the first web site.

6. The method of claim 4, wherein said providing the video comprises:
providing the video to the first web site for the first shopper with a first priority; and
providing the video to the first web site for the plurality of other shoppers with a second priority;
wherein the first priority is greater than the second priority.

7. The method of claim 1,
negotiating purchase by the first shopper of at least one item of the plurality of items, wherein said negotiating comprises:
receiving input from the first shopper requesting to negotiate for purchase of the at least one item;
receiving communication from a seller at the first location regarding terms of sale of the at least one item.

8. The method of claim 1,
negotiating purchase of at least one item of the plurality of items, wherein said negotiating is performed between an agent of the first shopper and a seller of the item.

9. The method of claim 1,
providing audio equipment for generating audio of the remote shopping event;
providing the audio of the remote shopping event to the first shopper.

10. The method of claim 1, further comprising:
receiving second input from the first shopper, wherein the second input from the shopper comprises one or more of:
a request for an agent to wear or use an item of the plurality of items; or
a request for information regarding an item of the plurality of items.

11. A system for conducting a remote shopping event for a first shopper, the system comprising:
one or more video cameras, operable to generate video corresponding to the remote shopping event, wherein the remote shopping event occurs at a first location;
a remote computer system coupled to the one or more video cameras, wherein the remote computer system stores program instructions executable by a processor of the remote computer system to:
receive instructions to direct operation of the one or more video cameras;
transmit the video of the one or more video cameras to a server computer system; and
the server computer system, wherein the server computer system is coupled to the remote computer system, wherein the server computer system stores program instructions executable by a processor of the server computer system to:
receive the video from the remote computer system;
provide the video to the first shopper over a wide area network, wherein the first shopper is located at a second location that is remote from the first location; and
receive input from the first shopper to direct the one or more video cameras to provide video of a plurality of items to the first shopper; and
transmit the input as the instructions to the remote computer system.

12. The system of claim 11, wherein the program instructions stored on the server computer system are further executable to:
receive input from the first shopper to purchase at least one item of the plurality of items displayed on the video.

13. The system of claim 11, wherein the program instructions stored on the server computer system are further executable to:
provide a sales price of an item of the plurality of items to the first shopper, wherein the sales price includes shipping and a transaction charge.

14. The system of claim 11,
wherein the server computer system providing the video comprises providing the video on a web site of the server computer system for presentation over the wide area network, wherein the video displayed on the web site is viewable by a plurality of other shoppers; and
wherein the program instructions stored on the server computer system are further executable to receive input from at least one of the plurality of other shoppers to purchase at least one item displayed on the video on the first web site.

15. The system of claim 14, further comprising:
one or more audio recording devices, operable to generate audio corresponding to the remote shopping event;
wherein the program instructions stored by the remote computer system are further executable to provide the audio to the server computer system, and wherein the audio is accessible by the plurality of other shoppers using the first web site.

16. The system of claim 14, wherein the server computer system providing the video comprises:
providing the video to the first web site for the first shopper with a first priority; and
providing the video to the first web site for the plurality of other shoppers with a second priority;
wherein the first priority is greater than the second priority.

17. The system of claim 11, wherein the program instructions stored by the server computer system are further executable to:
receive a request from the first shopper to negotiate a purchase of at least one item of the plurality of items.

18. The system of claim 11, further comprising:
one or more audio recording devices, operable to generate audio corresponding to the remote shopping event;
wherein the program instructions stored by the remote computer system are further executable to provide the audio to the server computer system

19. The system of claim 11, wherein the program instructions stored by the server computer system are further executable to receive second input from the first shopper, wherein the second input from the shopper comprises one or more of:
a request for an agent to wear or use an item of the plurality of items; or
a request for information regarding an item of the plurality of items.
